(19) United States
(12) Patent Application Publication
(10) Pub. No.: US 2024/0344890 A1
(43) Pub. Date: Oct. 17, 2024

(54) INFRARED THERMAL IMAGING TEMPERATURE MEASUREMENT METHOD AND DEVICE, STORAGE MEDIUM AND ELECTRONIC APPARATUS

(71) Applicant: AUTEL ROBOTICS CO., LTD., Shenzhen (CN)

(72) Inventor: Zhaozao LI, Shenzhen (CN)

(21) Appl. No.: 18/636,570

(22) Filed: Apr. 16, 2024

(30) Foreign Application Priority Data
Apr. 17, 2023 (CN) 202310459110.3

(51) Int. Cl. G01J 5/48; G01J 5/00; G01J 5/04; G01J 5/53

(52) U.S. Cl. CPC G01J 5/485; G01J 5/047; G01J 5/53; G01J 2005/0077

(57) ABSTRACT

The disclosure provides an infrared thermal imaging temperature measurement method and device, a storage medium and an electronic apparatus, and relate to the technical field of infrared thermal imaging, wherein the method includes acquiring first data output by a thermal imaging assembly mounted on a flying device with image collection of a target region using the flying device, wherein the first data at least includes an operating temperature of the thermal imaging assembly and an original gray value image output by the thermal imaging assembly during the image collection of the target region at the operating temperature; and determining measured temperature values corresponding to different sub-regions in the target region from calibration data and the first data information corresponding to the thermal imaging assembly.

### CROSS REFERENCE TO RELATED DISCLOSURE

This disclosure is filed based upon and claims priority to Chinese patent disclosure 202310459110.3, filed on Apr. 17, 2023 and entitled “Infrared thermal imaging temperature measurement method and device, storage medium and electronic apparatus” the entire disclosure of which is incorporated herein by reference for all purposes.

### BACKGROUND

The infrared thermal imaging is more and more widely used in the unmanned aerial vehicle (UAV). Especially, it has the function of temperature measurement, which becomes necessary. The temperature measurement can realize the real-time state analysis of the target, the precise search of the temperature region and the defect analysis of the object. However, since the temperature of the infrared thermal imaging detector changes within 5 minutes of power-on, the temperature measurement function of the infrared thermal imaging detector is unstable during this period, so that the temperature measurement accuracy is greatly reduced.

There is no effective solution to the problem of inaccurate temperature measurement caused by unstable temperature of thermal imaging detector in the related art.

### SUMMARY

Embodiments of the disclosure relate to the technical field of infrared thermal imaging, and in particular, to an infrared thermal imaging temperature measurement method and device, a storage medium and an electronic apparatus.

Embodiments of the disclosure provide an infrared thermal imaging temperature measurement method and device, a storage medium and an electronic apparatus, so as to solve the problem of inaccurate temperature measurement caused by the temperature instability of a thermal imaging detector.

According to an first aspect of the disclosure, an infrared thermal imaging temperature measurement method is provided, comprising: acquiring first data output by a thermal imaging assembly mounted on a flying device with image collection of a target region using the flying device, wherein the first data at least comprises an operating temperature of the thermal imaging assembly and an original gray value image output by the thermal imaging assembly during the image collection of the target region at the operating temperature; and determining measured temperature values corresponding to different sub-regions in the target region from calibration data and the first data information corresponding to the thermal imaging assembly.

According to a second aspect of the disclosure, an infrared thermal imaging temperature measurement device is further provided, comprising: an acquisition module configured for acquiring first data output by a thermal imaging assembly mounted on a flying device with image collection of a target region using the flying device, wherein the first data at least comprises an operating temperature of the thermal imaging assembly and an original gray value image output by the thermal imaging assembly during the image collection of the target region at the operating temperature; and a determination module configured for determining measured temperature values corresponding to different sub-regions in the target region from calibration data and the first data information corresponding to the thermal imaging assembly.

According to a third aspect of the disclosure, a computer-readable storage medium is also provided. The computer-readable storage medium has stored therein a computer program, wherein the computer program is executed to perform the steps in any of the above-mentioned method embodiments.

According to a fourth of the disclosure, an electronic apparatus is further provided, comprising a memory and a processor. The memory has stored therein a computer program. The processor is configured for performing the computer program to perform the steps in any of the above-mentioned method embodiments.

### BRIEF DESCRIPTION OF THE DRAWINGS

The accompanying drawings, which are incorporated in and constitute a part of this specification, illustrate embodiments consistent with the disclosure and, together with the description, serve to explain the principles of the disclosure.

In order to explain the embodiments of the disclosure or the technical solutions in the prior art more clearly, the following simple description will be given to the drawings which are used in the embodiments or the description of the prior art. It would be obvious for a person skilled in the art to obtain other drawings according to these drawings without involving any inventive effort.

FIG. 1 is a schematic diagram of an disclosure environment for an alternative infrared thermal imaging temperature measurement method according to an embodiment of the disclosure;

FIG. 2 is a flowchart of an infrared thermal imaging temperature measurement method according to an embodiment of the disclosure;

FIG. 3 is a schematic diagram of a temperature measurement model corresponding to an infrared thermal imaging detector according to an embodiment of the disclosure;

FIG. 4 is a schematic diagram (I) of a transformation of a gray value y and an operating temperature value x according to an alternative embodiment of the invention;

FIG. 5 is a schematic diagram (II) of a transformation of a grey value y and an operating temperature value x according to an alternative embodiment of the invention;

FIG. 6 is a schematic diagram (III) of a transformation of a grey value y and an operating temperature value x according to an alternative embodiment of the invention;

FIG. 7 is a structural block diagram of an infrared thermal imaging temperature measurement device according to an embodiment of the disclosure; and

FIG. 8 is a schematic structural diagram of an alternative electronic apparatus according to an embodiment of the disclosure.

### DETAILED DESCRIPTION

In order that those skilled in the art may better understand the solutions of the invention, a clear and complete description of the technical solutions of the embodiments of the invention is provided below. Obviously, the described embodiments are only part of the embodiments of the invention, rather than all of the embodiments. Based on the embodiments in the present invention, all other embodiments obtained by a person skilled in the art without involving any inventive effort should be within the scope of protection of the present invention.

It should be noted that the terms “first”, “second”, “third”, “fourth”, and the like in the description and claims of the invention and in the above-described figures are used for distinguishing between similar objects and not necessarily for describing a particular sequential or chronological order. It should be understood that the data so used may be interchanged, where appropriate, so that the embodiments of the invention described herein can be implemented in an order other than those illustrated or described herein. Furthermore, the terms “comprise” and “comprising”, as well as any variations thereof, are intended to cover a non-exclusive inclusion. For example, a process, a method, a system, an article, or a device that includes a list of steps or elements is not necessarily limited to those steps or elements expressly listed, but may include other steps or elements not expressly listed or inherent to such process, method, article, or device.

The disclosure is illustrated by the following embodiments.

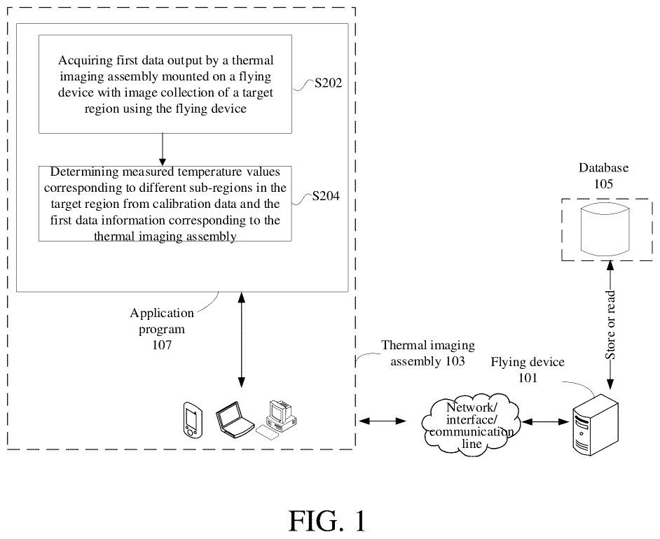

According to an aspect of an embodiment of the disclosure, an infrared thermal imaging temperature measurement method is provided. Alternatively, in this embodiment, the infrared thermal imaging temperature measurement method described above may be applied in a hardware environment consisting of a flying device 101 and a thermal imaging assembly 103 as shown in FIG. 1. As shown in FIG. 1, the flying device 101 is connected to the thermal imaging assembly 103 via a network or interface or communication line and may be used to service the thermal imaging assembly 103 or an disclosure 107 mounted on thermal imaging assembly 103. The disclosure 107 may be an infrared thermal imaging temperature measurement disclosure or the like. A database 105, for example, a temperature data storage database, an environmental data storage database, and a calibration information storage database, may be provided on or separate from the flying device 101 for providing data storage services to the flying device 101. The network may include, but is not limited to a wired network and a wireless network. The wired network includes a local area network, a metropolitan area network and a wide area network. The wireless network includes Bluetooth, WIFI and other networks for realizing wireless communication. The thermal imaging assembly 103 may be a terminal configured with an disclosure program, and may include but is not limited to a thermal imaging detector. The above-mentioned thermal imaging assembly 103 may be a single thermal imaging detector or a thermal imaging detection cluster composed of a plurality of thermal imaging detectors. The disclosure program 107 using the above-mentioned infrared thermal imaging temperature measurement method is displayed via the thermal imaging assembly 103 or other connected display devices.

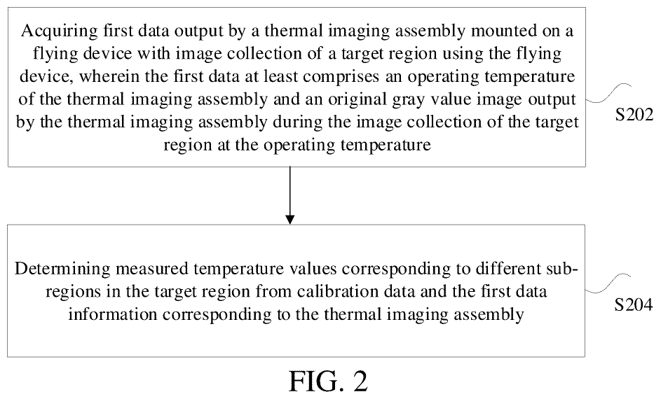

As shown in connection with FIG. 1, the above-mentioned infrared thermal imaging temperature measurement method may be implemented in the thermal imaging assembly 103 by steps S202-S206 in FIG. 2 as follows.

Alternatively, in this embodiment, the infrared thermal imaging temperature measurement method described above may also be implemented by a thermal imaging assembly, such as, for example, thermal imaging assembly 103 shown in FIG. 1; or by a combination of thermal imaging assemblies and flying devices.

The above is merely an example, and the present embodiment is not particularly limited.

Alternatively, as shown in FIG. 2, the infrared thermal imaging temperature measurement method described above may be applied in a flying device control system, the method including:

Step S202, acquiring first data output by a thermal imaging assembly mounted on a flying device with image collection of a target region using the flying device, wherein the first data at least comprises an operating temperature of the thermal imaging assembly and an original gray value image output by the thermal imaging assembly during the image collection of the target region at the operating temperature.

Alternatively, multiple sets of measurement information exist in the above-mentioned first data. Each group of measurement information corresponds to an associated operating temperature and an original grey value image, namely, when image collection is performed on the target region, the current operating temperature of the thermal imaging assembly may also be determined by a temperature device provided in the thermal imaging assembly, and the original grey value image corresponding to the current operating temperature may be recorded, so as to facilitate subsequent determination of the influence of the operating temperature on the original grey value image.

Step S204, determining measured temperature values corresponding to different sub-regions in the target region from calibration data and the first data information corresponding to the thermal imaging assembly.

As an alternative example, the above-mentioned thermal imaging assembly may be an infrared thermal imaging detector, and the infrared thermal imaging detector is additionally provided with a temperature measurement device for detecting the operating temperature of the infrared thermal imaging detector in real time. The temperature measurement device may be another temperature sensor or a thermometer. The environment temperature corresponding to the infrared thermal imaging detector after being operated on may be measured by the temperature measurement device, so that when the temperature value corresponding to the grey scale image is determined, the external temperature factor is reduced with reference to the measurement data, thereby greatly improving the accuracy of the determined temperature value.

In addition, when the thermal imaging assembly leaves the factory, the above-mentioned calibration data is determined by performing calibration on each black body with a different fixed temperature. The calibration is used to determine the operating temperature, the gray value image and the linear relationship between the black bodies with different temperatures corresponding to the thermal imaging assembly when the thermal imaging assembly reaches a maximum operating temperature or is on the way to reach the maximum temperature, so as to determine the corresponding numerical conversion relationship, thereby improving the efficiency of determining the temperature value and reducing the influence of the operating temperature of the thermal imaging assembly.

In an exemplary embodiment, the above-mentioned step S204 is implemented by: searching in the calibration data for sub-calibration data matched with an operating temperature included in the first data information; replacing a gray value in the original gray value image by using a corresponding relationship between a gray value and a target temperature value in the sub-calibration data to obtain a temperature value distribution image corresponding to the original gray value image; and determining measured temperature values corresponding to different sub-regions in the target region according to the temperature value distribution image.

It should be noted that when the sub-calibration data matched with the operating temperature is determined, it is mainly for knowing the black body temperature value corresponding to the current operating temperature at the time of calibration and the grayscale value image corresponding to the black body, and then determining the temperature value situation corresponding to different grayscale values in the original grayscale value image corresponding to the currently captured target region by the sub-calibration data. Finally, the temperature value distribution of the corresponding target region may be determined according to the original gray value image, so as to realize the rapid measurement of the temperature of the target region.

By means of the above-mentioned steps, when the flying device performs image collection on the target region, the first data output by a thermal imaging assembly is acquired, and the temperature values corresponding to different grey values in the original grey value image included in the current first data are determined in combination with the calibration data determined by a calibration test of the current thermal imaging assembly at the time of delivery. That is to say, the temperature values corresponding to different grey values in the current original grey value image are accurately determined by relationships existing between the grey values, the temperature values and the operating temperature in the calibration data, and interference of the operating temperature on the finally determined temperature values is reduced by delivery calibration so as to solve the problem of inaccurate temperature measurement caused by the temperature instability of the thermal imaging detector in the related art and improve the efficiency and accuracy of obtaining the temperature distribution of the target region by the thermal imaging detector.

In an exemplary embodiment, before the above-mentioned Step S202, the above-mentioned infrared thermal imaging temperature measurement method further includes: acquiring a first temperature value of a calibration object and determining second data information output by the thermal imaging assembly in a case where the thermal imaging assembly enters a calibration state, wherein the second data information includes: an operating temperature of the thermal imaging assembly and a target gray value image output by the thermal imaging assembly for image collection of the calibration object at the operating temperature; wherein the calibration object is a black body having a fixed pre-set temperature; performing a first analysis on the second data information to obtain a first relationship between the operating temperature and the target grey value image; and associating the first relationship with the first temperature value to generate a set of calibration information corresponding to the thermal imaging assembly.

It can be understood that before the thermal imaging assembly leaves the factory, in order to ensure that the temperature measurement performed by the subsequent thermal imaging assembly is not affected by the external temperature, a temperature measurement device for monitoring the ambient temperature around the thermal imaging assembly is mounted in the thermal imaging assembly. When leaving the factory, a calibration process is performed for the installed temperature measurement device. Specifically, after the thermal imaging assembly is powered on, the temperature measurement device is used to monitor the thermal imaging assembly to shoot gray value images of black bodies with different fixed temperature values under different power-on periods, and to count the data of the power-on contents within a pre-set period after shooting multiple times. Then a first corresponding relationship between the temperature of the thermal imaging assembly itself and the gray value image output by the thermal imaging assembly may be determined. In addition, a second corresponding relationship between the temperature value corresponding to the grey value image and the grey value image output by the thermal imaging assembly may also be determined. Thus, a set of calibration information may be determined by combining the first corresponding relationship and the second corresponding relationship.

As an optional example, the above-mentioned infrared thermal imaging temperature measurement method further includes: after associating the first relationship with the first temperature value and generating a set of calibration information corresponding to the thermal imaging assembly, performing a second analysis on the determined plurality of sets of calibration information in a case where there are multiple calibration objects, wherein the second analysis is used for selecting a plurality of grey value images with the same operating temperature of the thermal imaging assembly to perform average value processing; and determining a second relationship between the grey value images at the same operating temperature and temperature values corresponding to a plurality of calibration objects based on the processing result of the second analysis, so as to determine calibration data corresponding to the thermal imaging assembly according to the second relationship, the plurality of calibration objects and a plurality of sets of calibration information.

That is to say, in a case where there are a plurality of black bodies (equivalent to calibration objects in the embodiments of the present invention) with fixed temperature values, a first corresponding relationship between the operating temperature of each black body at different power-on periods of the thermal imaging assembly and the gray value image output by the thermal imaging assembly can be acquired, and average value processing is performed on the gray value images having the same operating temperature, thereby ensuring that effective processing may be performed on different gray value images corresponding to the same operating temperature.

Alternatively, the infrared thermal imaging temperature measurement method further comprises: after acquiring a first temperature value of a calibration object and determining second data information output by the thermal imaging assembly, determining a first time point at which the first temperature value is acquired and determining a second time point at which the thermal imaging assembly outputs second data information; calculating a target duration between the first time point and the second time point; and comparing the magnitude of the target duration with a preset duration to determine whether the second data information meets calibration requirements.

In simple terms, in order to ensure the calibration of the thermal imaging assembly is effective, after determining a first temperature value corresponding to a calibration object (namely, a black body with a fixed temperature value), we determine a duration relationship between a time point when the first temperature value is acquired and a time point when second data information output by the thermal imaging assembly is acquired. It can be determined whether the data collection amount of this calibration meets the requirements by the duration relationship, avoiding calibration differences caused by insufficient data, and improving the accuracy of temperature measurement.

Alternatively, the comparing the magnitude of the target duration with a preset duration to determine whether the second data information meets calibration requirements comprises: in a case where the target duration is less than the preset duration, determining that the second data information does not meet the calibration requirements, and prompting data information to be re-collected by the thermal imaging assembly; and in a case where the target duration is greater than or equal to a preset duration, determining that the second data information satisfies calibration requirements, and allowing data analysis to be performed on the second data information.

For example, assuming that the thermal imaging assembly is calibrated using a black body with a fixed temperature value, and the thermal imaging assembly reaches the maximum operating temperature after being powered on for 5 minutes. At this time, the operating temperature does not change any more. Thus, the second data with a duration of more than 5 minutes needs to be collected during the calibration, so as to ensure that, in the process of practical use, the temperature values matched with different grey values in the original grey value images of the target region photographed by the thermal imaging assembly at different operating temperatures can be accurately identified, which can realize rapid measurement of the temperature of the target region.

In an exemplary embodiment, the infrared thermal imaging temperature measurement method further comprises: after the determining measured temperature values corresponding to different sub-regions in the target region from calibration data and the first data information corresponding to the thermal imaging assembly, in a case where the measured temperature values corresponding to different sub-regions in the target region are greater than or equal to an alarm temperature value, determining that an abnormality exist in the temperature of the target region; and sending prompt information to a control terminal associated with the flying device, wherein the prompt information is used for prompting the use of a manipulation object of the control terminal to perform a routing inspection on the target region.

It can be understood that, in a case where the measured temperature values corresponding to different sub-regions in the target region are determined, it is further possible to determine whether there is an abnormal temperature in the target region by comparing the difference between the temperature value determined by the flying device system and the thermal imaging assembly and the alarm temperature value. When the abnormal temperature occurs, it prompts in time to use a manipulation object of a control terminal associated with the flying device to have a routing inspection on the target region so as to avoid a fire risk in the target region caused by an excessively high temperature.

In order to better understand the embodiments of the present invention and the technical solutions of the alternative embodiments, the flow of the infrared thermal imaging temperature measurement method described above is explained below with reference to examples, but is not intended to limit the technical solutions of the embodiments of the present invention.

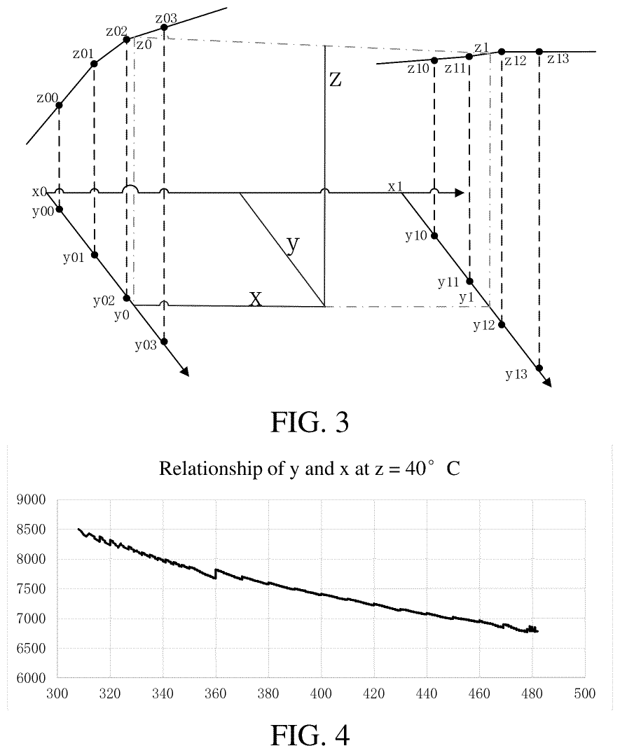

In an alternative example, FIG. 3 is a schematic diagram of a temperature measurement model corresponding to an infrared thermal imaging detector according to an embodiment of the disclosure. As shown in FIG. 3, the x-axis is the temperature of an infrared thermal imaging detector (equivalent to a thermal imaging assembly in the above-mentioned embodiment) itself, and is acquired from a thermometer (equivalent to a temperature measurement device in the above-mentioned embodiment). The y-axis is the original gray value of the images output by the infrared thermal imaging detector. The z-axis is the temperature value in the image.

Alternatively, the infrared thermal imaging detector is used to measure four black bodies at different temperatures.

When the temperature of the infrared thermal imaging detector which is just powered on is x₀, the four black body raw values (equivalent to the original grey values in the above-mentioned embodiment) output by the infrared thermal imaging detector are y00, y₀₁, y₀₂ and y₀₃, and the black body temperatures (equivalent to the measured temperature values in the above-mentioned embodiment) are z₀₀, z₀₁, z₀₂ and z₀₃ respectively.

When the temperature of the infrared thermal imaging detector is x1 after a period of power-on, the infrared thermal imaging detector outputs four black bodies to obtain four other raw values y₁₀, y₁₁, y₁₂ and y₁₃, corresponding to the black body temperatures z₁₀, z₁₁, z₁₂ and z₁₃.

From these two sets of calibration values, given the current detector's own temperature x, the Raw value y, the corresponding temperature value z in the corresponding image can be found by the following formula. Here,

$${z}_{0} = \{ \begin{matrix}{z}_{00} + \frac{( y - {y}_{00} ) ( {z}_{01} - {z}_{00} )}{{y}_{01} - {y}_{00}} when y < {y}_{01} ; \\ {z}_{01} + \frac{( y - {y}_{01} ) ( {z}_{02} - {z}_{01} )}{{y}_{02} - {y}_{01}} when {y}_{01} \leq y \leq {y}_{02} ; \\ {z}_{02} + \frac{( y - {y}_{02} ) ( {z}_{03} - {z}_{02} )}{{y}_{03} - {y}_{02}} when y > {y}_{02}\end{matrix} ;$$

$${z}_{1} = \{ \begin{matrix}{z}_{10} + \frac{( y - {y}_{10} ) ( {z}_{11} - {z}_{10} )}{{y}_{11} - {y}_{10}} when y < {y}_{11} ; \\ {z}_{11} + \frac{( y - {y}_{11} ) ( {z}_{12} - {z}_{11} )}{{y}_{12} - {y}_{11}} when {y}_{11} \leq y \leq {y}_{12} ; \\ {z}_{12} + \frac{( y - {y}_{12} ) ( {z}_{13} - {z}_{12} )}{{y}_{13} - {y}_{12}} when y > {y}_{12}\end{matrix} ;$$

$$z = {z}_{0} + \frac{( x - {x}_{0} ) ( {z}_{1} - {z}_{0} )}{{x}_{1} - {x}_{0}} .$$

In addition, when the fixed temperature values corresponding to different calibration black bodies are known, an inverse inference can be made on the above formula to determine the Raw value y to which the fixed temperature value can correspond. Specifically,

$${y}_{0} = \{ \begin{matrix}{y}_{00} + \frac{( z - {z}_{00} ) ( {y}_{01} - {y}_{00} )}{{z}_{01} - {z}_{00}} when z < {z}_{01} ; \\ {y}_{01} + \frac{( z - {z}_{01} ) ( {y}_{02} - {y}_{01} )}{{z}_{02} - {z}_{01}} when {z}_{01} \leq z \leq {z}_{02} ; \\ {y}_{02} + \frac{( z - {z}_{02} ) ( {y}_{03} - {y}_{02} )}{{z}_{03} - {z}_{02}} when z > {z}_{02}\end{matrix} ;$$

$${y}_{1} = \{ \begin{matrix}{y}_{10} + \frac{( z - {z}_{10} ) ( {y}_{11} - {y}_{10} )}{{z}_{11} - {z}_{10}} when z < {z}_{11} ; \\ {y}_{11} + \frac{( z - {z}_{11} ) ( {y}_{12} - {y}_{11} )}{{z}_{12} - {z}_{11}} when {z}_{11} \leq z \leq {z}_{12} ; \\ {y}_{12} + \frac{( z - {z}_{12} ) ( {y}_{13} - {y}_{12} )}{{z}_{13} - {z}_{12}} when z > {z}_{12}\end{matrix} ;$$

$$y = {y}_{0} + \frac{( x - {x}_{0} ) ( {y}_{1} - {y}_{0} )}{{x}_{1} - {x}_{0}} .$$

It should be noted that, according to the formula derived from the above model, the temperature deviation is very large when the same black body is measured by the same detector at different times, with multiple test measurements. It shows that the temperature of the detector itself affects the measured temperature, so it is impossible to simply take two measurements of x₀ and x₁. In fact, it is impossible to make calibration of four black bodies at the factory just at the absolute time points x₀ and x₁. Thus, it is necessary to calibrate more x values and then fit the actual values.

As an alternative embodiment, on the basis of the above-mentioned derivation, it can also be determined that when the temperature value z to be measured of the black body is fixed, several groups of relationships between y and x can be tested. For example, when the temperature value z to be measured of the black body is 40 degrees, the temperature change curve of the original grey value y of the output image of the infrared thermal imaging detector and the operating temperature value x of the infrared thermal imaging detector itself at a certain time point C can be determined. Optionally, FIG. 4 is a schematic diagram (I) of a transformation of a gray value y and an operating temperature value x according to an alternative embodiment of the invention.

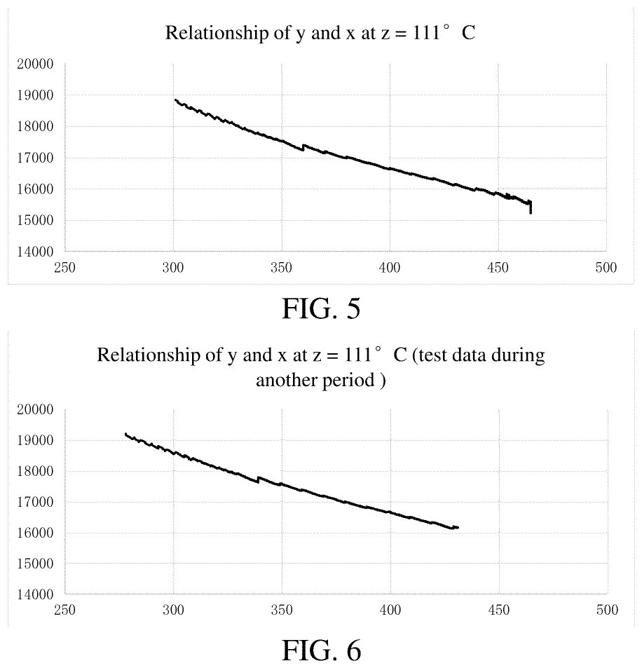

Alternatively, FIG. 5 is a schematic diagram (II) of a transformation of a grey value y and an operating temperature value x according to an alternative embodiment of the invention. When the measured temperature value z of the black body is 111 degrees, the temperature change curve of the original gray value y of the output images of the corresponding infrared thermal imaging detector and the operating temperature value x of the infrared thermal imaging detector itself at a certain time point C can be determined.

Alternatively, FIG. 6 is a schematic diagram (III) of a transformation of a grey value y and an operating temperature value x according to an alternative embodiment of the invention. When the measured temperature value z of the black body is 111 degrees, the temperature change curve of the original gray value y of the output images of the corresponding infrared thermal imaging detector and the operating temperature value x of the infrared thermal imaging detector itself at a time point C corresponding to a certain other test time can be determined.

Therefore, by combining the above-mentioned temperature change curve, it can be determined that the original gray value y of the output image of the infrared thermal imaging detector and the operating temperature value x of the infrared thermal imaging detector itself are approximately in a direct relationship: y=ax+b;

It can be understood that, during calibration, the infrared thermal imaging detector lens faces the black body z0, power-on statistics is performed for 5 minutes, and the original gray value y of the image corresponding to the temperature x and the Raw original image data from the infrared thermal imaging detector obtained every second is recorded. If the Raw with the same detector temperature takes their average value, the statistical relationship between y and x is obtained as follows.

$${y}_{00} = {a}_{0} {x}_{00} + {b}_{0} ;$$

$${y}_{01} = {a}_{0} {x}_{01} + {b}_{0} ;$$

$${y}_{02} = {a}_{0} {x}_{02} + {b}_{0} ;$$

$$…$$

$${y}_{0 n} = {a}_{0} {x}_{0 n} + {b}_{0} .$$

Thus, by calculating the above-mentioned relationship, the variation parameter a₀ and b₀ between the infrared thermal imaging detector temperature x and the original gray value y of the image can be obtained and the correlation relationship between the both can be determined.

$${a}_{0} = \frac{{Σ}_{i = 1}^{i = n} \frac{{y}_{0 i} - {y}_{0 ( i - 1 )}}{{x}_{0 i} - {x}_{0 ( i - 1 )}}}{n} ; {b}_{0} = \frac{{Σ}_{i = 0}^{i = n} {y}_{0 i} - a {Σ}_{i = 0}^{i = n} {x}_{0 i}}{n + 1} .$$

By the same reasoning, in a case where the black body temperature z₀ is known, a transformation formula y₀−a₀x₀+b₀ between the infrared thermal imaging detector temperature x and the original grey value y of the image can be obtained: y₀=a₀x₀+b, so that when either one of the temperature x from the infrared thermal imaging detector and the original gray value of the image is known, it can be quickly converted to the other one. The above-mentioned four black bodies used for calibration are determined by using the above-mentioned adjustment method. When the temperature values corresponding to different black bodies are known, the transformation formula between the temperature x from the infrared thermal imaging detector corresponding to the black body Z₁ and the original gray value y of the image is determined: y₁=a₁x₁+b₁. The transformation formula between the temperature x from the infrared thermal imaging detector corresponding to the black body Z₂ and the original gray value y of the image is determined: y₂=a₂x₂+b₂. The transformation formula between the temperature x of the infrared thermal imaging detector corresponding to the black body Z₃ and the original gray value y of the image is determined: y₃=a₃x₃+b₃.

Then, the above-mentioned derivation formula is transformed to finally obtain:

$$y = \{ \begin{matrix}{y}_{0} + \frac{( z - {z}_{0} ) ( {y}_{1} - {y}_{0} )}{{z}_{1} - {z}_{0}} when z < {z}_{1} ; \\ {y}_{1} + \frac{( z - {z}_{1} ) ( {y}_{2} - {y}_{1} )}{{z}_{2} - {z}_{1}} when {z}_{1} \leq z \leq {z}_{2} ; \\ {y}_{2} + \frac{( z - {z}_{2} ) ( {y}_{3} - {y}_{2} )}{{z}_{3} - {z}_{2}} when z > {z}_{2}\end{matrix} ;$$

$$z = \{ \begin{matrix}{z}_{0} + \frac{( y - {y}_{0} ) ( {z}_{1} - {z}_{0} )}{{y}_{1} - {y}_{0}} when y < {y}_{1} ; \\ {z}_{1} + \frac{( y - {y}_{1} ) ( {z}_{2} - {z}_{1} )}{{y}_{2} - {y}_{1}} when {y}_{1} \leq y \leq {y}_{2} ; \\ {y}_{2} + \frac{( y - {y}_{2} ) ( {z}_{3} - {z}_{2} )}{{y}_{3} - {y}_{2}} when y > {y}_{2}\end{matrix} ;$$

It should be noted that when the calibration needs to be performed by using black bodies with different temperatures of 4 or more, the above-mentioned temperature measurement formula can be extended to:

$$y = \{ \begin{matrix}{y}_{0} + \frac{( z - {z}_{0} ) ( {y}_{1} - {y}_{0} )}{{z}_{1} - {z}_{0}} when z < {z}_{1} ; \\ {y}_{1} + \frac{( z - {z}_{1} ) ( {y}_{2} - {y}_{1} )}{{z}_{2} - {z}_{1}} when {z}_{1} \leq z \leq {z}_{2} ; \\ … … \\ {y}_{N - 3} + \frac{( z - {z}_{N - 3} ) ( {y}_{N - 2} - {y}_{N - 3} )}{{z}_{N - 2} - {z}_{N - 3}} when {z}_{N - 3} \leq z \leq {z}_{N - 2} ; \\ {y}_{N - 2} + \frac{( z - {z}_{N - 2} ) ( {y}_{N - 1} - {y}_{N - 2} )}{{z}_{N - 1} - {z}_{N - 2}} when z > {z}_{N - 2} ;\end{matrix} ;$$

$$z = \{ \begin{matrix}{z}_{0} + \frac{( y - {y}_{0} ) ( {z}_{1} - {z}_{0} )}{{y}_{1} - {y}_{0}} when y < {y}_{1} ; \\ {z}_{1} + \frac{( y - {y}_{1} ) ( {z}_{2} - {z}_{1} )}{{y}_{2} - {y}_{1}} when {y}_{1} \leq y \leq {y}_{2} ; \\ … … \\ {y}_{N - 3} + \frac{( y - {y}_{N - 3} ) ( {z}_{N - 2} - {z}_{N - 3} )}{{y}_{N - 2} - {y}_{N - 3}} when {y}_{N - 3} \leq y \leq {y}_{N - 2} ; \\ {y}_{N - 2} + \frac{( y - {y}_{N - 2} ) ( {z}_{N - 1} - {z}_{N - 2} )}{{y}_{N - 1} - {y}_{N - 2}} when y > {y}_{N - 2} ;\end{matrix} ;$$

That is, in practical disclosures, the value of the temperature can be obtained from the thermometer value x and the actual raw value. The more the black bodies, the more the calibration time points, the higher the temperature measurement accuracy.

In brief, the temperature x of the infrared thermal imaging detector and the original gray value y of the image can be numerically converted by a black body with a fixed temperature value. Then the original gray value y is replaced with a0x0+b0 under the condition that the conversion relationship between the original gray value y and the temperature value z in the image is determined, so that the measurement temperature corresponding to the region to be measured by the infrared thermal imaging detector can be directly determined under the condition that the temperature x from the infrared thermal imaging detector is known according to the replacement relationship, thereby achieving rapid temperature measurement of the target region.

Alternatively, the determining measured temperature values corresponding to different sub-regions in the target region from calibration data and the first data information corresponding to the thermal imaging assembly comprises: searching in the calibration data for sub-calibration data matched with an operating temperature included in the first data information; replacing a gray value in the original gray value image by using a corresponding relationship between a gray value and a target temperature value in the sub-calibration data to obtain a temperature value distribution image corresponding to the original gray value image; and determining measured temperature values corresponding to different sub-regions in the target region according to the temperature value distribution image.

Alternatively, the infrared thermal imaging temperature measurement method further comprises: acquiring a first temperature value of a calibration object and determining second data information output by the thermal imaging assembly in a case where the thermal imaging assembly enters a calibration state before acquiring the first data output by the thermal imaging assembly mounted on the flying device in a case where the flying device is used to perform image collection on a target region, wherein the second data information comprises: an operating temperature of the thermal imaging assembly and a target gray value image output by the thermal imaging assembly for image collection of the calibration object at the operating temperature; wherein the calibration object is a black body having a fixed pre-set temperature; performing a first analysis on the second data information to obtain a first relationship between the operating temperature and the target grey value image; and associating the first relationship with the first temperature value to generate a set of calibration information corresponding to the thermal imaging assembly.

Alternatively, the infrared thermal imaging temperature measurement method further comprises: after associating the first relationship with the first temperature value and generating a set of calibration information corresponding to the thermal imaging assembly, performing a second analysis on the determined plurality of sets of calibration information in a case where there are multiple calibration objects, wherein the second analysis is used for selecting a plurality of grey value images with the same operating temperature of the thermal imaging assembly to perform average value processing; and determining a second relationship between the grey value images at the same operating temperature and temperature values corresponding to a plurality of calibration objects based on the processing result of the second analysis, so as to determine calibration data corresponding to the thermal imaging assembly according to the second relationship, the plurality of calibration objects and a plurality of sets of calibration information.

Alternatively, the infrared thermal imaging temperature measurement method further comprises: after acquiring a first temperature value of a calibration object and determining second data information output by the thermal imaging assembly, determining a first time point at which the first temperature value is acquired and determining a second time point at which the thermal imaging assembly outputs second data information; calculating a target duration between the first time point and the second time point; and comparing the magnitude of the target duration with a preset duration to determine whether the second data information meets calibration requirements.

Alternatively, the comparing the magnitude of the target duration with a preset duration to determine whether the second data information meets calibration requirements comprises: in a case where the target duration is less than the preset duration, determining that the second data information does not meet the calibration requirements, and prompting data information to be re-collected by the thermal imaging assembly; and in a case where the target duration is greater than or equal to a preset duration, determining that the second data information satisfies calibration requirements, and allowing data analysis to be performed on the second data information.

Alternatively, the infrared thermal imaging temperature measurement method further comprises: after the determining measured temperature values corresponding to different sub-regions in the target region from calibration data and the first data information corresponding to the thermal imaging assembly, in a case where the measured temperature values corresponding to different sub-regions in the target region are greater than or equal to an alarm temperature value, determining that an abnormality exist in the temperature of the target region; and sending prompt information to a control terminal associated with the flying device, wherein the prompt information is used for prompting the use of a manipulation object of the control terminal to perform a routing inspection on the target region.

In summary, according to the above-mentioned alternative embodiment, a temperature measurement device (such as a thermometer) is added by the infrared thermal imaging detector to detect the ambient temperature of the detector in real time. Before leaving the factory, the infrared thermal imaging lens calibrates the black bodies with various temperatures, and calibrates the corresponding parameters. In practical disclosure, according to the actual detector output value and the thermometer value, as well as the value calibrated before delivery, the temperature value is calculated. The infrared thermal imaging is used to realize the temperature measurement function, so as to avoid the problem of inaccurate temperature measurement caused by the temperature instability of the detector itself, and to realize the efficiency of adding thermal imaging assemblies to the flying device for temperature measurement. In this way, it can give consideration to users who normally use unmanned aerial vehicles. It is flexible and convenient, and the use scene is wider.

It should be noted that each of the foregoing method embodiments, for purposes of simplicity of description, is presented as a series of combinations of acts, but those of skill in the art will know that the invention are not limited by the order of acts described, as some steps may occur in other orders or concurrently with other acts in accordance with the invention. Furthermore, those skilled in the art should also appreciate that the embodiments described in the description are presently considered to be preferred, and that actions and modules involved are not necessarily required to practice the invention.

From the description of the implementations given above, it will be clear to a person skilled in the art that the method according to the embodiments described above can be implemented by means of software plus a necessary general hardware platform, but of course also by means of hardware, but in many cases the former is a better implementation. Based on this understanding, the technical solution of the invention may be essentially or a part of making a contribution to the prior art may be embodied in the form of a software product that is stored in a storage medium and that includes instructions for causing a computer device (which may be a smartphone, a personal computer, a server, or a network device, etc.) to perform all or part of the steps of the methods of the various embodiments of the present invention.

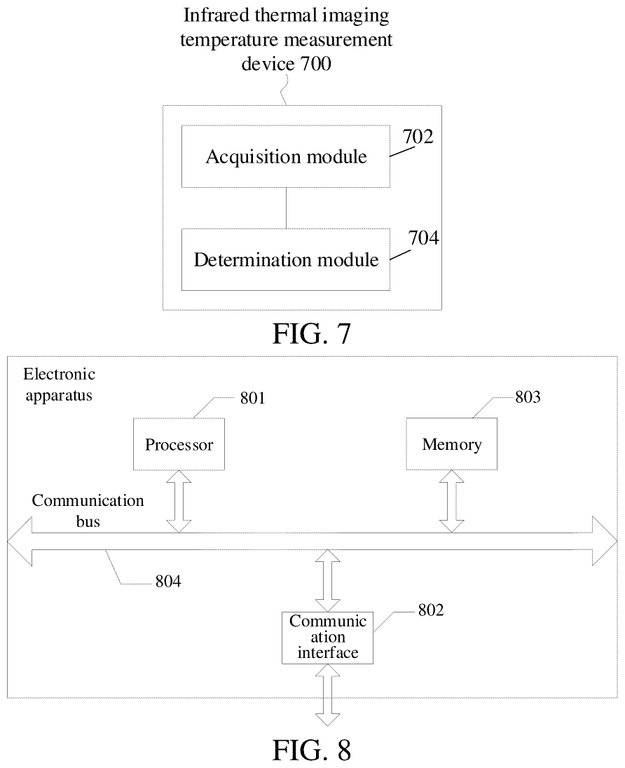

In accordance with another aspect of an embodiment of the present invention, an infrared thermal imaging temperature measurement device 700 is also provided. As shown in FIG. 7, the device includes:

an acquisition module 702 configured for acquiring first data output by a thermal imaging assembly mounted on a flying device with image collection of a target region using the flying device, wherein the first data at least comprises an operating temperature of the thermal imaging assembly and an original gray value image output by the thermal imaging assembly during the image collection of the target region at the operating temperature; and

a determination module 704 configured for determining measured temperature values corresponding to different sub-regions in the target region from calibration data and the first data information corresponding to the thermal imaging assembly. Among them, the calibration data is data determined by the thermal imaging assembly performing calibration by a black body with a fixed temperature when leaving the factory.

By means of the above-mentioned device, when the flying device performs image collection on the target region, the first data output by a thermal imaging assembly is acquired, and the temperature values corresponding to different grey values in the original grey value image included in the current first data are determined in combination with the calibration data determined by a calibration test of the current thermal imaging assembly at the time of delivery. That is to say, the temperature values corresponding to different grey values in the current original grey value image are accurately determined by relationships existing between the grey values, the temperature values and the operating temperature in the calibration data, and interference of the operating temperature on the finally determined temperature values is reduced by delivery calibration so as to solve the problem of inaccurate temperature measurement caused by the temperature instability of the thermal imaging detector in the related art and improve the efficiency and accuracy of obtaining the temperature distribution of the target region by the thermal imaging detector.

In an exemplary embodiment, the determination module is further configured for searching in the calibration data for sub-calibration data matched with an operating temperature included in the first data information; replacing a gray value in the original gray value image by using a corresponding relationship between a gray value and a target temperature value in the sub-calibration data to obtain a temperature value distribution image corresponding to the original gray value image; and determining measured temperature values corresponding to different sub-regions in the target region according to the temperature value distribution image.

In an exemplary embodiment, the infrared thermal imaging temperature measurement device further includes a calibration module configured for acquiring a first temperature value of a calibration object and determining second data information output by the thermal imaging assembly in a case where the thermal imaging assembly enters a calibration state before acquiring the first data output by the thermal imaging assembly mounted on the flying device in a case where the flying device is used to perform image collection on a target region, wherein the second data information comprises: an operating temperature of the thermal imaging assembly and a target gray value image output by the thermal imaging assembly for image collection of the calibration object at the operating temperature; wherein the calibration object is a black body having a fixed pre-set temperature; performing a first analysis on the second data information to obtain a first relationship between the operating temperature and the target grey value image; and associating the first relationship with the first temperature value to generate a set of calibration information corresponding to the thermal imaging assembly.

In an exemplary embodiment, the calibration module further includes an analysis unit configured for, after associating the first relationship with the first temperature value and generating a set of calibration information corresponding to the thermal imaging assembly, performing a second analysis on the determined plurality of sets of calibration information in a case where there are multiple calibration objects, wherein the second analysis is used for selecting a plurality of grey value images with the same operating temperature of the thermal imaging assembly to perform average value processing; and determining a second relationship between the grey value images at the same operating temperature and temperature values corresponding to a plurality of calibration objects based on the processing result of the second analysis, so as to determine calibration data corresponding to the thermal imaging assembly according to the second relationship, the plurality of calibration objects and a plurality of sets of calibration information.

In an exemplary embodiment, the calibration module further includes a time unit configured for, after acquiring a first temperature value of a calibration object and determining second data information output by the thermal imaging assembly, determining a first time point at which the first temperature value is acquired and determining a second time point at which the thermal imaging assembly outputs second data information; calculating a target duration between the first time point and the second time point; and comparing the magnitude of the target duration with a preset duration to determine whether the second data information meets calibration requirements.

In an exemplary embodiment, the above-mentioned time unit is further configured for, in a case where the target duration is less than the preset duration, determining that the second data information does not meet the calibration requirements, and prompting data information to be re-collected by the thermal imaging assembly; and in a case where the target duration is greater than or equal to a preset duration, determining that the second data information satisfies calibration requirements, and allowing data analysis to be performed on the second data information.

In an exemplary embodiment, the infrared thermal imaging temperature measurement device further includes a prompt module, further configured for after the determining measured temperature values corresponding to different sub-regions in the target region from calibration data and the first data information corresponding to the thermal imaging assembly, in a case where the measured temperature values corresponding to different sub-regions in the target region are greater than or equal to an alarm temperature value, determining that an abnormality exist in the temperature of the target region; and sending prompt information to a control terminal associated with the flying device, wherein the prompt information is used for prompting the use of a manipulation object of the control terminal to perform a routing inspection on the target region.

It should be noted that each of the above-mentioned units can be realized by software or hardware. For the latter, it can be realized by the following means, but is not limited thereto. The above-mentioned units are all located in the same processor. Alternatively, the various elements described above may reside in different processors in any combination.

Embodiments of the present invention also provide a storage medium having a computer program stored therein. The computer program is arranged to perform the steps of any of the method embodiments described above when run.

Alternatively, in this embodiment, the above-mentioned storage medium may be arranged to store a computer program for performing the steps of:
acquiring first data output by a thermal imaging assembly mounted on a flying device with image collection of a target region using the flying device, wherein the first data at least comprises an operating temperature of the thermal imaging assembly and an original gray value image output by the thermal imaging assembly during the image collection of the target region at the operating temperature; and
determining measured temperature values corresponding to different sub-regions in the target region from calibration data and the first data information corresponding to the thermal imaging assembly.

Alternatively, in the present embodiment, the above-mentioned storage medium may include, but is not limited to a USB flash disk, a Read-Only Memory (ROM), a Random Access Memory (RAM), a mobile hard disk drive, a magnetic disk or an optical disk, and other media which can store computer programs.

Alternatively, specific examples in the present embodiment may refer to the examples described in the above embodiments and alternative embodiments. The present embodiment will not be described in detail herein.

According to an aspect of an embodiment of the disclosure, there is provided a schematic structural diagram of an electronic apparatus for implementing the above-mentioned infrared thermal imaging temperature measurement method. As shown in FIG. 8, the electronic apparatus includes a processor 801, a communication interface 802, a memory 803 and a communication bus 804. The processor 801, the communication interface 802 and the memory 803 complete communication with each other via the communication bus 804.

Among them, the memory 803 is configured for storing a computer program.

The processor 801 is configured for, when executing a computer program stored on the memory 803, implementing the steps of:
acquiring first data output by a thermal imaging assembly mounted on a flying device with image collection of a target region using the flying device, wherein the first data at least comprises an operating temperature of the thermal imaging assembly and an original gray value image output by the thermal imaging assembly during the image collection of the target region at the operating temperature; and
determining measured temperature values corresponding to different sub-regions in the target region from calibration data and the first data information corresponding to the thermal imaging assembly.

Alternatively, the communication bus may be a PCI (Peripheral Component Interconnect) bus, or an EISA (Extended Industry Standard Architecture) bus or the like. The communication bus may be divided into an address bus, a data bus, a control bus, etc. For ease of illustration, only one bold line is shown in FIG. 8, but it is not shown that there is only one bus or type of bus. The communication interface is used for communication between the electronic apparatus and other apparatuses.

The volatile memory may include an RAM or may include a non-volatile memory, e.g., at least one magnetic disk memory. Optionally, the memory may also be at least one storage device located remotely from the aforementioned processor.

The processor may be a general purpose processor and may include, but is not limited to CPU (Central Processing Unit), NP (Network Processor), etc.; also possible is DSP (Digital Signal Processing), ASIC (Disclosure Specific Integrated Circuit), FPGA (Field-Programmable Gate Array) or other programmable logic devices, discrete gate or transistor logic devices, and discrete hardware components.

Alternatively, specific examples of the present embodiment may refer to the examples described in the above-mentioned embodiments, and the present embodiment will not be described in detail herein.

It will be understood by those skilled in the art that the structure shown in FIG. 8 is merely illustrative, and that the electronic apparatus implementing the above-mentioned infrared thermal imaging temperature measurement method may be a terminal device, which may be a smart phone (such as an Android cell phone, an iOS cell phone, etc.), a tablet computer, a palmtop computer, a Mobile Internet Device (MID), a PAD, a thermal imaging assembly, a flying device, etc. FIG. 8 does not limit the structure of the electronic apparatus described above. For example, the electronic apparatus may also include more or fewer components (e.g. network interfaces, display devices, etc.) than those shown in FIG. 8, or have a different configuration than that shown in FIG. 8.

The above-mentioned serial numbers of the embodiments of the present invention are merely for the purpose of description and do not represent the advantages and disadvantages of the embodiments.

The integrated unit in the above-mentioned embodiments, if implemented in the form of a software functional unit and sold or used as a stand-alone product, may be stored in the above-mentioned computer-readable storage medium. Based on this understanding, the solution of the invention may be essentially or a part of making a contribution to the prior art or a part of the solution may be embodied in the form of a software product that is stored in a storage medium and that includes instructions for causing one or more computer devices (which may be a personal computer, a server, or a network device, etc.) to perform all or part of the steps of the methods of the various embodiments of the present invention.

In the above-mentioned embodiments of the invention, the description of each embodiment has its own emphasis, and parts of one embodiment which are not described in detail may be referred to the description of other embodiments.

In the several embodiments provided in the disclosure, it should be understood that the disclosed client end may be implemented in other ways. Among them, the device embodiments described above are merely illustrative. For example, the partitioning of elements is merely a logical function partitioning, and actual implementations may have additional partitioning, e.g., multiple elements or components may be combined or integrated into another system, or some features may be omitted, or not performed. In another aspect, the couplings or direct couplings or communication connections shown or discussed with respect to each other may be indirect couplings or communication connections via some interfaces, modules, or units, and may be electrical or other forms.

The elements illustrated as separate elements may or may not be physically separate, and the components shown as elements may or may not be physical elements, i.e., may be located at one place, or may be distributed across multiple network elements. Some or all of the elements can be selected according to actual needs to achieve the purpose of the solution of the embodiment.

In addition, each functional unit in each embodiment of the invention may be integrated in one processing unit, or may be physically present separately from each unit. Two or more units may also be integrated in one unit. The above-mentioned integrated units may be implemented in the form of hardware or in the form of software functional units.

By means of the disclosure, when the flying device performs image collection on the target region, the first data output by a thermal imaging assembly is acquired, and the temperature values corresponding to different grey values in the original grey value image included in the current first data are determined in combination with the calibration data determined by a calibration test of the current thermal imaging assembly at the time of delivery. That is to say, the temperature values corresponding to different grey values in the current original grey value image are accurately determined by relationships existing between the grey values, the temperature values and the operating temperature in the calibration data, and interference of the operating temperature on the finally determined temperature values is reduced by delivery calibration so as to solve the problem of inaccurate temperature measurement caused by the temperature instability of the thermal imaging detector in the related art and improve the efficiency and accuracy of obtaining the temperature distribution of the target region by the thermal imaging detector.

The above mentioned are only preferred implementations of the invention. It will be appreciated by those skilled in the art that some modifications and adaptations may be made without departing from the principle of the invention, and such modifications and alterations are intended to be included within the scope of the invention.

What is claimed is:

1. An infrared thermal imaging temperature measurement method, comprising:
acquiring a first data output by a thermal imaging assembly mounted on a flying device with image collection of a target region using the flying device, wherein the first data at least comprises an operating temperature of the thermal imaging assembly and an original gray value image output by the thermal imaging assembly during the image collection of the target region at the operating temperature; and
determining measured temperature values corresponding to different sub-regions in the target region from calibration data and the first data information corresponding to the thermal imaging assembly.

2. The infrared thermal imaging temperature measurement method according to claim 1, wherein the determining measured temperature values corresponding to different sub-regions in the target region from calibration data and the first data information corresponding to the thermal imaging assembly comprises:
searching in the calibration data for sub-calibration data matched with an operating temperature included in the first data information;
replacing a gray value in the original gray value image by using a corresponding relationship between a gray value and a target temperature value in the sub-calibration data to obtain a temperature value distribution image corresponding to the original gray value image; and
determining measured temperature values corresponding to different sub-regions in the target region according to the temperature value distribution image.

3. The infrared thermal imaging temperature measurement method according to claim 1, wherein the method further comprises:
when the thermal imaging assembly enters a calibration state, acquiring a first temperature value of a calibration object and determining second data information output by the thermal imaging assembly, wherein the second data information comprises an operating temperature of the thermal imaging assembly and a target gray value image output by the thermal imaging assembly during the image collection of the calibration object at the operating temperature; the calibration object is a black body having a fixed pre-set temperature;
performing a first analysis on the second data information to obtain a first relationship between the operating temperature and the target grey value image; and
associating the first relationship with the first temperature value to generate a set of calibration information corresponding to the thermal imaging assembly.

4. The infrared thermal imaging temperature measurement method according to claim 3, wherein the method further comprises:
when there are a plurality of calibration objects, performing a second analysis on the determined plurality of sets of calibration information, wherein the second analysis is configured to select a plurality of grey value images with the same operating temperature of the thermal imaging assembly to perform average value processing;
determining a second relationship between the grey value images at the same operating temperature and temperature values corresponding to a plurality of calibration objects based on the processing result of the second analysis, so as to determine calibration data corresponding to the thermal imaging assembly according to the second relationship, the plurality of calibration objects and a plurality of sets of calibration information.

5. The infrared thermal imaging temperature measurement method according to claim 3, wherein the method further comprises:
determining a first time point at which the first temperature value is acquired and determining a second time point at which the thermal imaging assembly outputs second data information;
calculating a target duration between the first time point and the second time point; and
comparing the magnitude of the target duration with a preset duration to determine whether the second data information meets calibration requirements.

6. The infrared thermal imaging temperature measurement method according to claim 5, wherein the comparing the magnitude of the target duration with a preset duration to determine whether the second data information meets the calibration requirements comprises:
when the target duration is less than the preset duration, determining that the second data information does not meet the calibration requirements, and prompting data information to be re-collected by the thermal imaging assembly; and
when the target duration is greater than or equal to a preset duration, determining that the second data information satisfies calibration requirements, and allowing data analysis to be performed on the second data information.

7. The infrared thermal imaging temperature measurement method according to claim 1, wherein the method further comprises:
when the measured temperature values corresponding to different sub-regions in the target region are greater than or equal to an alarm temperature value, determining that an abnormality exist in the temperature of the target region; and
sending prompt information to a control terminal associated with the flying device, wherein the prompt information is used for prompting the use of a manipulation object of the control terminal to perform a routing inspection on the target region.

8. An infrared thermal imaging temperature measurement device, wherein the device comprises:
an acquisition module configured for acquiring first data output by a thermal imaging assembly mounted on a flying device with image collection of a target region using the flying device, wherein the first data at least comprises an operating temperature of the thermal imaging assembly and an original gray value image output by the thermal imaging assembly during the image collection of the target region at the operating temperature; and
a determination module configured for determining measured temperature values corresponding to different sub-regions in the target region from calibration data and the first data information corresponding to the thermal imaging assembly.

9. The infrared thermal imaging temperature measurement device according to claim 8, wherein the determination module is further configured for:
searching in the calibration data for sub-calibration data matched with an operating temperature included in the first data information;
replacing a gray value in the original gray value image by using a corresponding relationship between a gray value and a target temperature value in the sub-calibration data to obtain a temperature value distribution image corresponding to the original gray value image; and
determining measured temperature values corresponding to different sub-regions in the target region according to the temperature value distribution image.

10. The infrared thermal imaging temperature measurement device according to claim 8, wherein the device further comprises:
when the thermal imaging assembly enters a calibration state, acquiring a first temperature value of a calibration object and determining second data information output by the thermal imaging assembly, wherein the second data information comprises an operating temperature of the thermal imaging assembly and a target gray value image output by the thermal imaging assembly during the image collection of the calibration object at the operating temperature; the calibration object is a black body having a fixed pre-set temperature;
performing a first analysis on the second data information to obtain a first relationship between the operating temperature and the target grey value image; and
associating the first relationship with the first temperature value to generate a set of calibration information corresponding to the thermal imaging assembly.

11. The infrared thermal imaging temperature measurement device according to claim 10, wherein the device further comprises:
when there are a plurality of calibration objects, performing a second analysis on the determined plurality of sets of calibration information, wherein the second analysis is configured to select a plurality of grey value images with the same operating temperature of the thermal imaging assembly to perform average value processing;
determining a second relationship between the grey value images at the same operating temperature and temperature values corresponding to a plurality of calibration objects based on the processing result of the second analysis, so as to determine calibration data corresponding to the thermal imaging assembly according to the second relationship, the plurality of calibration objects and a plurality of sets of calibration information.

12. The infrared thermal imaging temperature measurement device according to claim 11, wherein the device further comprises:
determining a first time point at which the first temperature value is acquired and determining a second time point at which the thermal imaging assembly outputs second data information;
calculating a target duration between the first time point and the second time point; and
comparing the magnitude of the target duration with a preset duration to determine whether the second data information meets calibration requirements.

13. The infrared thermal imaging temperature measurement device according to claim 12, wherein the device further comprises:
when the target duration is less than the preset duration, determining that the second data information does not meet the calibration requirements, and prompting data information to be re-collected by the thermal imaging assembly; and
when the target duration is greater than or equal to a preset duration, determining that the second data information satisfies calibration requirements, and allowing data analysis to be performed on the second data information.

14. The infrared thermal imaging temperature measurement device according to claim 8, wherein the determination module is further configured for:
when the measured temperature values corresponding to different sub-regions in the target region are greater than or equal to an alarm temperature value, determining that an abnormality exist in the temperature of the target region; and
sending prompt information to a control terminal associated with the flying device, wherein the prompt information is used for prompting the use of a manipulation object of the control terminal to perform a routing inspection on the target region.

15. A non-transitory computer-readable storage medium, wherein the computer-readable storage medium has stored a computer program, wherein the computer program is executed to perform an infrared thermal imaging temperature measurement method, wherein the infrared thermal imaging temperature measurement method comprises:
acquiring a first data output by a thermal imaging assembly mounted on a flying device with image collection of a target region using the flying device, wherein the first data at least comprises an operating temperature of the thermal imaging assembly and an original gray value image output by the thermal imaging assembly during the image collection of the target region at the operating temperature; and
determining measured temperature values corresponding to different sub-regions in the target region from calibration data and the first data information corresponding to the thermal imaging assembly.

16. The non-transitory computer-readable storage medium according to claim 15, wherein the determining measured temperature values corresponding to different sub-regions in the target region from the calibration data and the first data information corresponding to the thermal imaging assembly comprises:
searching in the calibration data for sub-calibration data matched with an operating temperature included in the first data information;
replacing a gray value in the original gray value image by using a corresponding relationship between a gray value and a target temperature value in the sub-calibration data to obtain a temperature value distribution image corresponding to the original gray value image; and
determining measured temperature values corresponding to different sub-regions in the target region according to the temperature value distribution image.

17. The non-transitory computer-readable storage medium according to claim 15, wherein the method further comprises:
when the thermal imaging assembly enters a calibration state, acquiring a first temperature value of a calibration object and determining second data information output by the thermal imaging assembly, wherein the second data information comprises an operating temperature of the thermal imaging assembly and a target gray value image output by the thermal imaging assembly during the image collection of the calibration object at the operating temperature; the calibration object is a black body having a fixed pre-set temperature;
performing a first analysis on the second data information to obtain a first relationship between the operating temperature and the target grey value image; and
associating the first relationship with the first temperature value to generate a set of calibration information corresponding to the thermal imaging assembly.

18. The non-transitory computer-readable storage medium according to claim 17, wherein the method further comprises:
when there are a plurality of calibration objects, performing a second analysis on the determined plurality of sets of calibration information, wherein the second analysis is configured to select a plurality of grey value images with the same operating temperature of the thermal imaging assembly to perform average value processing;
determining a second relationship between the grey value images at the same operating temperature and temperature values corresponding to a plurality of calibration objects based on the processing result of the second analysis, so as to determine calibration data corresponding to the thermal imaging assembly according to the second relationship, the plurality of calibration objects and a plurality of sets of calibration information.

19. The non-transitory computer-readable storage medium according to claim 17, wherein the method further comprises:
determining a first time point at which the first temperature value is acquired and determining a second time point at which the thermal imaging assembly outputs second data information;
calculating a target duration between the first time point and the second time point; and
comparing the magnitude of the target duration with a preset duration to determine whether the second data information meets calibration requirements.

20. The non-transitory computer-readable storage medium according to claim 19, wherein the comparing the magnitude of the target duration with a preset duration to determine whether the second data information meets the calibration requirements comprises:
when the target duration is less than the preset duration, determining that the second data information does not meet the calibration requirements, and prompting data information to be re-collected by the thermal imaging assembly; and
when the target duration is greater than or equal to a preset duration, determining that the second data information satisfies calibration requirements, and allowing data analysis to be performed on the second data information.
